(19) United States
(12) Patent Application Publication
(10) Pub. No.: US 2005/0078332 A1
(43) Pub. Date: Apr. 14, 2005

(54) System and method for controlling a printer job responsive to attribute analysis

(75) Inventor: Jerry Lee Brown, Vancouver, WA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/685,229

(22) Filed: Oct. 14, 2003

(51) Int. Cl. G06F 3/12; H04L 9/32; G06F 13/10; G05B 19/00

(52) U.S. Cl. 358/1.14; 358/1.15; 358/1.9; 340/5.2

(57) ABSTRACT

A job attribute analysis system and method are provided for controlling a printer. The method comprises: accepting a job request; analyzing attributes of the requested job; and, controlling the job output in response to the attribute analysis. Typically, a job is accepted with an associated user identification (ID). Then, the method establishes a list of permitted attributes cross-referenced to user ID. The attributes of the requested job are analyzed by comparing the analyzed attributes to permitted attributes. The list of permitted attributes may additionally be cross-referencing quotas. Analyzing job attributes involves the consideration of whether the job is to be printed is color or monochrome. Other attributes can be the paper size, tray to be used, document content, media type, simplex/duplex, stapling, and/or whether hole punching is requested. With respect to document content, the method may additionally concern itself with restricted text strings, watermarks, and/or color images.

### BACKGROUND OF THE INVENTION

1. Field of the Invention

This invention generally relates to digital imaging and document processes and, more particularly, to a system and method for controlling copy or print job outputs on the basis of attributes associated with the job to be performed.

2. Description of the Related Art

A conventional printer may impose user account restrictions based on quotas, user identifications (IDs), or net addresses. As used herein, the term “printer” refers to a class of devices that supply a paper product output, such a copier, a printer accepting electronically formatted documents, a fax, or a multifunctional peripheral (MFP). For example, a particular user may be restricted to printing only at certain machines, or a user might be given a quota for copying. Another restriction could be in limiting the number of pages that can be printed in a certain period of time. Once that quota is reached, the user can do no more until their account receives more “credit”. However, this quota method does not restrict the types of print jobs or copies that can be made. If 100 pages are allowed, as an example, the user is permitted to print 100 letter-sized pages, or 100 legal-sized pages. The account usually does not distinguish between the types of output.

FIG. 1 is a diagram of a system where document security is provided using a network server (prior art). In this system, account restrictions are established only if a separate server or device containing a database of user IDs and restrictions is used. Data for print jobs goes through the server and is analyzed at that point. This process has a security loophole in that a user may be able to access the printer directly instead of sending data through the server, in which case user identifications are not checked and data is not analyzed.

In other conventional printers, the machine recognizes a bar code or other encryptions in the print media, and does not copy or print if a code is recognized. However, this process does not discriminate between authorized and unauthorized users. Neither does the process evaluate the (information) content written on the print medium.

It would be advantageous if a printer could control its output in response to attributes associated with a requested job, such as the use of color inks, special media, or of valuable system resources.

It would be advantageous if a printer could control its output in response to the content of a requested job.

### SUMMARY OF THE INVENTION

Unlike some conventional systems, the present invention printer controller holds account IDs and distinguishes between types of jobs, without use of an intermediate server. Using a color printer as an example, this invention permits an administrator to restrict the use of color, saving the more expensive color consumables for authorized users only. In addition, documents containing large, resource-consuming images can be excluded. The account restrictions can be customized to the needs of the user, and to the policies of the printer administrator.

Unlike some systems that strictly prohibit the printing of documents with a watermark or embedded code, the present invention printer selectively prints a proprietary document containing a type of security watermark or code, if the user account is set up to permit it. In this way, a shared printer is usable in an environment in which users have different levels of security clearance. Additionally, the examination of the print job contents can go beyond a check of simple document attributes to include types of data, and even security restrictions based upon the document content. Here, document content is intended to described words, word strings, or images written on a print medium.

Accordingly, a job attribute analysis method is provided for controlling a printer. The method comprises: accepting a job request; analyzing attributes of the requested job; and, controlling the job output in response to the attribute analysis. Typically, a job is accepted with an associated user ID. Then, the method establishes a list of permitted attributes cross-referenced to user ID. The attributes of the requested job are analyzed by comparing the analyzed attributes to permitted attributes. In some aspects of the method, the list of permitted attributes may additionally be cross-referenced to quotas.

Analyzing job attributes may involves the consideration of whether the job to be printed is color or monochrome. Other attributes can be the paper size, tray to be used, document content, media type, simplex/duplex, stapling, and/or whether hole punching is requested. If the document content attribute is issue, the method may additionally concern itself with restricted text strings, watermarks, and/or color images.

If an electronic copy of a job is received, the attribute analysis process could involve the analysis of attributes expressed in a printer description language (PDL) and/or printer job language (PJL). If a hardcopy of job is received, the user ID and attribute commands can be entered at the printer front panel.

Additional details of the above-described method, and a job attribute analysis system for controlling a printer, are provided below.

### BRIEF DESCRIPTION OF THE DRAWINGS

FIG. 1 is a diagram of a system where document security is provided using a network server (prior art).

FIG. 2 is a schematic block diagram of the present invention job attribute analysis system for controlling a printer.

FIG. 3 is a diagram of an exemplary attribute chart cross-referenced to user IDs.

FIG. 4 illustrates an alternate depiction of the present invention job attribute analysis system.

FIG. 5 is a flowchart illustrating the present invention job attribute analysis method for controlling a printer.

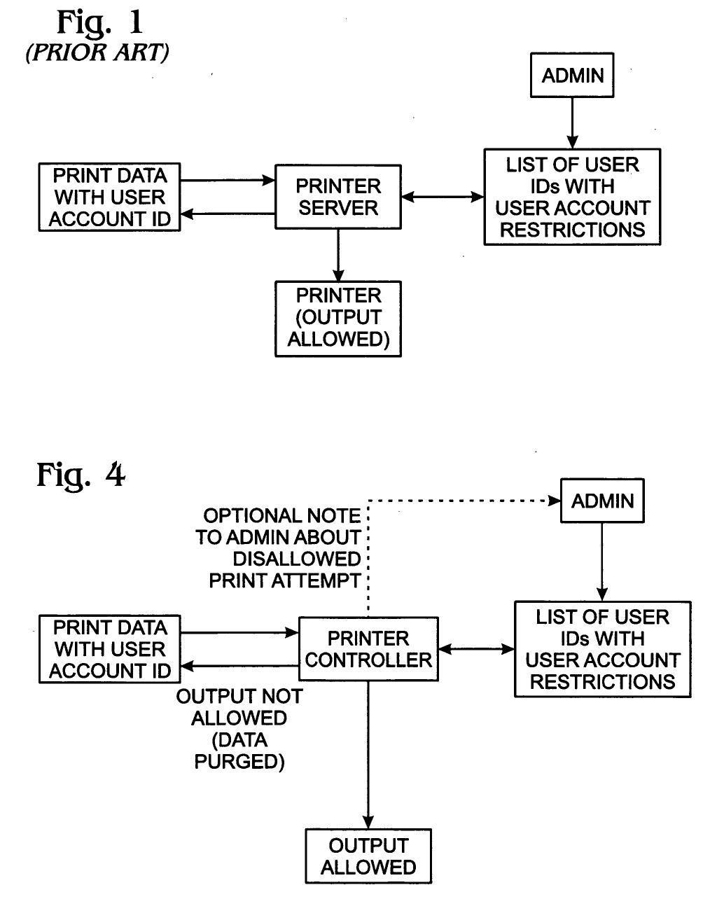

### DETAILED DESCRIPTION OF THE PREFERRED EMBODIMENTS

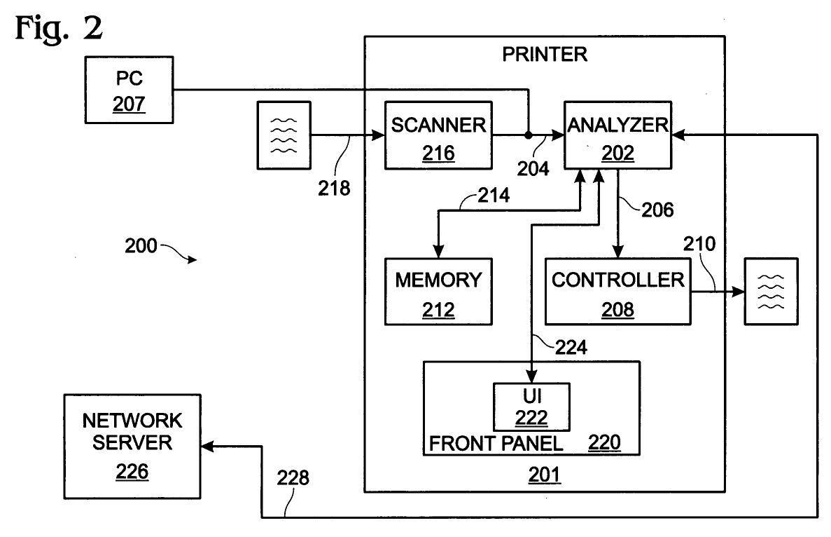

FIG. 2 is a schematic block diagram of the present invention job attribute analysis system for controlling a printer. The system 200 comprises a printer 201 with an analyzer 202 having an interface on line 204 to accept a job request and an interface on line 206 to supply job control commands in response to analyzing attributes of the requested copy job. As shown, the analyzer 202 may receive the job from a client device, such as a personal computer (PC) 207 (with a print driver) having an interface on line 204. In this circumstance, the attributes are expressed in the print driver commands and/or in printer languages.

A controller 208 has an interface on line 206 to accept the job control commands and an interface to accept the job. For simplicity, it is assumed in the figure that the document is passed through the analyzer 204 to the controller 208. The controller 208 also has an interface on 210 to supply a job output responsive to the job control commands. Typically, the job output, as described herein, is a print media product. However, the invention is also applicable to electronic document products, in which case the attributes would involve considerations of file size, file type, memory allocation, and processing time.

In some aspects the system 200 includes a memory 212 including a list of permitted attributes cross-referenced to user IDs. Then, the analyzer 202 accepts a job with an associated user ID, accesses the memory 212 via line 214, and compares the analyzed attributes to permitted attributes. The analyzer 202 supplies job control commands on line 206 responsive to the comparison of analyzed attributes to permitted attributes.

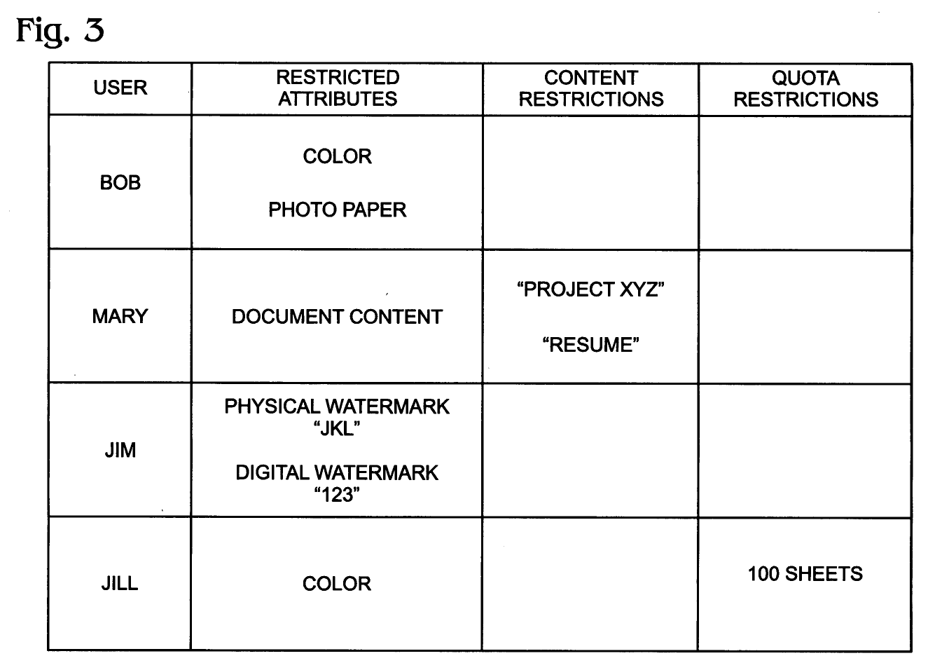

FIG. 3 is a diagram of an exemplary attribute chart cross-referenced to user IDs. Note that although the user IDs are shown as being associated with individuals, in other aspects the identification may be based upon business division, document source, or document destination, to name but a few examples. The analyzer may consider attributes such as whether the job to be printed is in color or in monochrome (color/monochrome). Other considerations may be paper size, document content, media type, whether the document is to be printed single or double-sided (simplex/duplex), stapled, and/or punched for holes. The selected tray may also be analyzed, typically as an indirect means of controlling the type of paper being used.

With respect to the document content attribute, the analyzer may consider restricted text strings, watermarks, and/or whether the job involves the reproduction of a color image. For example, text strings associated with a trade secret product may be recognized as an attribute. If the analyzer accepts an electronic copy of a job request for printing, it may analyze a digital watermark embedded in the electronic copy of the accepted job. The digital watermark might be a symbol that is inserted into the document that is not printed, or a field in a document control communication.

In other aspects, the memory additionally includes permitted attributes cross-referenced to quotas, and the analyzer supplies job commands in response to the permitted attribute quota. Alternately, the analyzer job commands include a command disallowing a job output in response to the attribute analysis.

Returning to FIG. 2, the system 200 may further comprise a scanner 216 having an interface on line 218 to accept a hardcopy of a job for copying. The scanner 216 has an interface on line 204 to supply an electronic copy of the requested job to the analyzer 202. Then, the analyzer 202 analyzes a (physical) watermark encoded in the hardcopy of the accepted job. Note, the scanner 216 actually detects the watermark in the print media as part of the scanning process. However, the analyzer 202 interprets or separates the watermark data from the information (document content) information.

In some aspects, the analyzer 202 accepts an electronic copy of the requested job formatted in a printer description language (PDL) and wrapped in a printer job language (PJL). Then, the analyzer 202 analyzes attributes of the requested job by analyzing attributes expressed in the PJL commands and analyzing attributes expressed in the PDL commands. Attributes are often expressed in these languages, sometimes as a default setting. In some aspects, there is a language hierarchy established where attributes expressed in PDL may override attributes expressed in PJL, if attributes associated with a job are in conflict. Likewise, the system 200 may use attributes associated with print driver instructions or instructions entered on a printer front panel as the ultimate attribute selection authority. In some aspects, the analyzer 202 may additionally analyze the document content, as described above.

In some aspects, a printer front panel 220 has a user interface (UI) 222 to accept a user ID and copy job attribute commands (requests). The front panel 220 has an interface on line 224 to supply the entered user ID and commands to the analyzer 202. Then, the analyzer 202 analyzes the commands entered at the front panel 220 of the printer 201. As explained above, permitted attributes associated with a particular user ID may be compared the attributes selected at the front panel 220. In addition, the analyzer 202 may also analyze the document content.

In other aspects, the analyzer 202 may send a notice to a user associated with the requested job, of the controls imposed upon the job output, via the front panel 220. If a job was sent from the PC 207, the notice can be delivered to a PC UI (not shown). In some aspects, the system further comprises a network server 226 having an interface on line 228 connected to the analyzer 202. Line 228 may represent a local area network (LAN) or Internet network connection for example. In this aspect, the analyzer 202 sends a notice to an administrator associated with the printer 201 accepting the requested job, via the network server 226. The notice describes any controls imposed upon the job output. In other aspects, any controls that are imposed on a job output can be saved in the printer memory for periodic retrieval by an administrator.

### Functional Description

The present invention prevents the unauthorized use of a printer or MFP by limiting the type or content of a document that can be printed. For example, a user account can be restricted to printing only letter-sized documents, or only monochrome documents. This serves to restrict the use of consumables by a particular user, or group of users. Conventional quota setting methods limit the number of jobs, or pages for a particular user account, regardless of job type, or require the use of an intermediate server. The present invention examines the content and attributes of a print job in the controller itself, and imposes restrictions based on what is found. Thus, a greater granularity is permitted in setting up user accounts. In this way, differing levels of security restrictions can also be imposed on user accounts. A first group of users can be prevented from printing certain documents, but a second group of users may print the same documents, all without the necessity of a separate server to perform the control and analysis function.

As a print or copy job is received, the controller examines the data and looks for certain attributes, such as:
Color vs. monochrome
Paper size
Media type
Simplex vs. duplex
Staple
hole punch.

Note, the invention is not limited to any particular list or combination of attributes. Once the attributes of the print or copy job are determined, they are compared with a list of restrictions imposed on the user, since the user account was set up or last modified by the account administrator. The print or copy job is then allowed or not, in response to the results of this comparison. An additional quota by job type can also be imposed. The controller can also search for certain data watermarks, security codes, or other items, and restrict usage by what is found.

FIG. 4 illustrates an alternate depiction of the present invention job attribute analysis system. The user sends print data from a workstation to a print controller using an account identification, as may be provided by the printer or network resource administrator. In current Sharp products AR-275 and ARM-450, the printer controller uses the same user identifications as is established for the copier. The ID is added in the “Job Control” dialogue box in the printer driver. Likewise, a printer driver can be used in a similar way, to add an ID to the print job. In the case of direct printing, a printer utility is used to add the ID to the print data. This account ID is associated with a list of print job restrictions that is stored in the printer's memory. The user's account ID is used to compare the attributes of the current print job to that list of restrictions set up and maintained in the printer memory.

This attribute comparison can be performed on three levels. Initially, the printer controller sniffer reads the PJL wrapper from the print job, and determines which PJL commands are utilized. These commands are checked against the list of allowed/disallowed PJL commands. On the next level, the header from the printer language, such as PCL5e or Post Script (PS), is checked for particular language commands that are allowed or disallowed. Note that the list of permitted attributes may vary depending upon the analysis. Finally, the data of the print job itself is checked, looking for particular data sequences that are disallowed. In some aspects, the disallowed data sequences are of length sufficient to make the odds of a random match, with a legitimate data sequence, small.

If the user is allowed to print items with the attributes, commands, or data found in the content of the print job, the output is allowed. However, if one or more of the attributes of the print job is found to be disallowed for that user, a notification is sent to the user and the print data is purged. Optionally, a notification can be sent to the administrator that an attempt has been made to print a disallowed item. In other aspects, a quota type control is exercised over the job output.

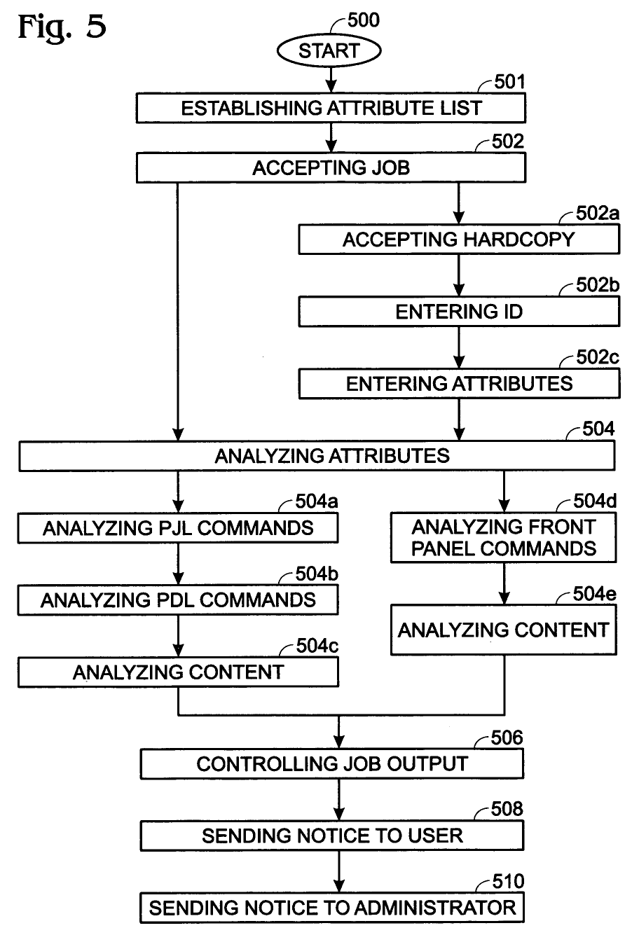

FIG. 5 is a flowchart illustrating the present invention job attribute analysis method for controlling a printer. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence.

The method starts at Step 500. Step 502 accepts a job request. Step 504 analyzes attributes of the requested job. Step 506 controls the job output in response to the attribute analysis. In one aspect, Step 506 disallows a job output in response to the attribute analysis. Step 508 sends a notice to a user associated with the requested job, of the controls imposed upon the job output. Step 510 sends a notice to an administrator associated with a printer accepting the requested copy job, of the controls imposed upon the job output.

In some aspects of the method, accepting a job request in Step 502 includes accepting a job with an associated user ID. Then, the method comprises a further step, Step 501, of establishing a list of permitted attributes cross-referenced to user ID. Analyzing attributes of the requested job in Step 504 includes comparing the analyzed attributes to permitted attributes, and controlling a job output in Step 506 includes supplying printer output responsive to the comparison of analyzed attributes to permitted attributes.

Analyzing attributes (Step 504) may include the consideration of color/monochrome, paper size, tray, document content, media type, simplex/duplex, staple, and hole punch attributes. With respect to document content attributes, restricted text strings, watermarks, and/or color images may be considered. A document with a color image may be considered a wasted resource when reproduced by some users.

When an electronic copy of a job request for printing is accepted in Step 502, then Step 504 may analyze a digital watermark embedded in the electronic copy of the accepted job. When a hardcopy of a job request for copying is accepted in Step 502, then Step 504 may analyze a watermark encoded in the hardcopy of the accepted job.

In some aspects, establishing a list of permitted attributes cross-referenced to user ID in Step 501 includes additionally cross-referencing permitted attributes to quotas. Then, controlling a job output in response to the attribute analysis (Step 506) includes supplying printed output in response to the permitted attribute quota.

In other aspects, Step 502 accepts an electronic copy of the requested job formatted in a printer description language (PDL) and wrapped in a printer job language (PJL). Then, Step 504 includes substeps. Step 504a analyzes attributes expressed in the PJL commands. Step 504b analyzes attributes expressed in the PDL commands. Step 504c analyzes the document content.

In one aspect, Step 502 includes substeps. Step 502a accepts a hardcopy of the requested job at a printer scanner. Step 502b enters a user ID at a front panel of the printer. Step 502c enters attributes for the requested job. Then, Step 504 includes alternate substeps. Step 504d analyzes commands entered at the front panel of the printer. Step 504e analyzes the document content.

A system and method have been providing for imposing controls on printer jobs through the analysis of attributes associated with the requested jobs. A few examples have been given of the types of attributes that can be analyzed. However, the invention is not limited to merely this group of examples. Examples have also been given of attribute analysis means and job control responses. Again, the invention is not limited to just these examples. Other variations and embodiments of the invention will occur to those skilled in the art.

1. A job attribute analysis method for controlling a printer, the method comprising:
accepting a job request;
analyzing attributes of the requested job; and,
controlling the job output in response to the attribute analysis.

2. The method of claim 1 wherein accepting a job request includes accepting a job with an associated user identification (ID); and,
the method further comprising:
establishing a list of permitted attributes cross-referenced to user ID; and,
wherein analyzing attributes of the requested job includes comparing the analyzed attributes to permitted attributes; and,
wherein controlling a job output in response to the attribute analysis includes supplying printer output responsive to the comparison of analyzed attributes to permitted attributes.

3. The method of claim 2 wherein analyzing attributes of the requested job includes forming a group of attributes including color/monochrome, paper size, tray, document content, media type, simplex/duplex, staple, and hole punch attributes, and selecting from that group.

4. The method of claim 3 wherein document content attributes form a group of document content attributes including restricted text strings, watermarks, and color images, and selecting from that group.

5. The method of claim 4 wherein accepting a job request includes accepting an electronic copy of a job request for printing; and,
wherein analyzing a watermark attribute includes analyzing a digital watermark embedded in the electronic copy of the accepted job.

6. The method of claim 4 wherein accepting a job request includes accepting a hardcopy of a job request for copying; and,
wherein analyzing a watermark attribute includes analyzing a watermark encoded in the hardcopy of the accepted job.

7. The method of claim 3 wherein establishing a list of permitted attributes cross-referenced to user ID includes additionally cross-referencing permitted attributes to quotas; and,
wherein controlling a job output in response to the attribute analysis includes supplying printed output in response to the permitted attribute quota.

8. The method of claim 3 wherein accepting a job request includes accepting an electronic copy of the requested job formatted in a printer description language (PDL) and wrapped in a printer job language (PJL); and,
wherein analyzing attributes of the requested job includes:
analyzing attributes expressed in the PJL commands;
analyzing attributes expressed in the PDL commands; and,
analyzing the document content.

9. The method of claim 3 wherein accepting a job request includes:
accepting a hardcopy of the requested job at a printer scanner;
entering a user ID at a front panel of the printer; and,
entering attributes for the requested job; and,
wherein analyzing attributes of the requested copy job includes:
analyzing commands entered at the front panel of the printer; and,
analyzing the document content.

10. The method of claim 1 wherein controlling the job output in response to the attribute analysis includes disallowing a job output in response to the attribute analysis.

11. The method of claim 1 further comprising:
sending a notice to a user associated with the requested job, of the controls imposed upon the job output.

12. The method of claim 1 further comprising:
sending a notice to an administrator associated with a printer accepting the requested copy job, of the controls imposed upon the job output.

13. A job attribute analysis system for controlling a printer, the system comprising:
an analyzer having an interface to accept a job request and an interface to supply job control commands in response to analyzing attributes of the requested copy job; and,
a controller having an interface to accept the job control commands, an interface to accept the job, and an interface to supply a job output responsive to the job control commands.

14. The system of claim 13 further comprising:
a memory including a list of permitted attributes cross-referenced to user identifications (IDs);
wherein the analyzer accepts a job with an associated user ID, accesses the memory, compares the analyzed attributes to permitted attributes, and supplies job control commands responsive to the comparison of analyzed attributes to permitted attributes.

15. The system of claim 14 wherein the analyzer analyzes a requested job group of attributes including color/monochrome, paper size, tray, document content, media type, simplex/duplex, staple, and hole punch attributes, and selecting from that group.

16. The system of claim 15 wherein the analyzer analyzes a document content group of attributes including restricted text strings, watermarks, and color images, and selecting from that group.

17. The system of claim 16 wherein the analyzer accepts an electronic copy of a job request for printing and analyzes a digital watermark embedded in the electronic copy of the accepted job.

18. The system of claim 16 further comprising:
a scanner having an interface to accept a hardcopy of a job for copying and an interface to supply an electronic copy of the requested job to the analyzer; and,
wherein the analyzer analyzes a watermark encoded in the hardcopy of the accepted job.

19. The system of claim 15 wherein the memory additionally includes permitted attributes cross-referencing to quotas; and,
wherein the analyzer supplies job commands in response to the permitted attribute quota.

20. The system of claim 15 wherein the analyzer accepts an electronic copy of the requested job formatted in a printer description language (PDL) and wrapped in a printer job language (PJL), and analyzes attributes of the requested job by:
analyzing attributes expressed in the PJL commands;
analyzing attributes expressed in the PDL commands; and,
analyzing the document content.

21. The system of claim 15 further comprising:
a scanner having an interface to accept a hardcopy of a job request for printing and an interface to supply an electronic copy of the job to the analyzer;
a printer front panel having a user interface (UI) to accept a user ID and requested copy job attribute commands, and an interface to supply the entered user ID and commands to the analyzer;
wherein the analyzer analyzes attributes of the requested job by:
analyzing commands entered at the front panel of the printer; and,
analyzing the document content.

22. The system of claim 13 wherein the analyzer job commands include a command disallowing a job output in response to the attribute analysis.

23. The system of claim 13 further comprising:
a printer front panel having a UI and an interface connected to the analyzer; and,
wherein the analyzer sends a notice to a user associated with the requested job, of the controls imposed upon the job output, via the front panel.

24. The system of claim 13 further comprising:
a network server having an interface connected to the analyzer; and,
wherein the analyzer sends a notice to an administrator associated with a printer accepting the requested job, of the controls imposed upon the job output, via the network server.

25. The system of claim 13 further comprising:
a client device having a UI and a print driver with an interface for sending jobs to the printer analyzer; and,
wherein the analyzer sends a notice to a user associated with the requested job, of the controls imposed upon the job output, via the client device UI.
